(19) United States
(12) Patent Application Publication
(10) Pub. No.: US 2008/0305942 A1
(43) Pub. Date: Dec. 11, 2008

(54) Oxynitride Armour Glass

(75) Inventors: Leonardus Johannes M.G. Dortmans, Ede (NL); Dennis De Graaf, Eindhoven (NL)

Correspondence Address: MORRISON & FOERSTER LLP, 12531 HIGH BLUFF DRIVE, SUITE 100, SAN DIEGO, CA, 92130-2040, US

(73) Assignee: Nederlandse Organisatie voor toegepast- natuuwetenschappelijk Onderzoek TNO, Delft (NL)

(21) Appl. No.: 11/917,906

(22) PCT Filed: Jun. 20, 2006
(86) PCT No.: PCT/NL2006/000302

§ 371 Date: May 8, 2008

(30) Foreign Application Priority Data
Jun. 21, 2005 (EP) 05076450.5

(51) Int. Cl. C03C 3/068

(52) U.S. Cl. 501/73; 501/11

(57) ABSTRACT

The present invention relates to the use of an oxynitride glass comprising a combination of glass network modifying cations as an armour material. The invention further relates to a novel oxynitride glass comprising a combination of glass network modifying cations and to a novel method for preparing an oxynitride glass comprising a combination of glass network modifying cations.

The invention relates to the use of an oxynitride glass as an armour material. The invention further relates to a novel oxynitride glass.

Armour materials, in particular materials used as an anti-ballistic material need to have a high resistance against high velocity impact against bullets and/or other missiles. An indicative value to judge such resistance is the D-value, which can be calculated with the following formula:

$$D = \frac{H * E}{{K}_{Ic}^{2}} * \sqrt{\frac{E}{ρ}}$$

wherein:

H=hardness in GPa

K_{Ic}=fracture toughness in MPa·m^{1/2}

E=Young's modulus in GPa

ρ=density in g/cm³

The higher the D-value the better the impact resistance. In order to get an indication of the suitability of a material as an armour material, one may determine Dᵣₑₗ which is the ratio of the D-value of the material and the D-value of float glass. Thus, Dᵣₑₗ for float glass is 1.0. For example, polycrystalline α-aluminium oxide, may have a Dᵣₑₗ of about 1.9, which makes it a suitable armour material. YAG (Y₃Al₅O₁₂) has a Dᵣₑₗ of only about 1.0, whereby its performance is not better than float glass.

Transparent armour articles may be made of transparent glass or transparent ceramics. Such materials find use in e.g. transports such as cars, aircraft and boats, and in counters, boots and the like.

Known armour glasses are suitable to protect against relatively light ammunition. In order to be effective against heavier ammunition, the material needs to be thicker. Depending on the type of threat, armour glasses need to have thicknesses ranging from 5 cm to 20 cm. The dimensions and the resulting weight of these articles make the material generally undesirable and in particular unacceptable for use in helicopters and other aircraft.

Ceramic armour materials tend to be much stronger than conventional glass materials and can therefore be made into thinner articles. However, ceramic armour materials are usually more difficult to form into transparent articles of a complex shape (such as curved shapes) or large articles than armour glasses. As a result, a transparent ceramic armour tends to be very expensive.

Donald R. Messier (American Ceramic Society Bulletin, 68 (1989) November, No 11, p 1931-1936) refers to M-Si—Al—O—N glass materials (M being one of Ca, Li, Mg or Y). The use of oxynitride glasses for use in transparent armour and glass fibres for resin-matrix composites is suggested. It is not suggested to use a specific combination of Ca, Li, Mg and Y, let alone of Mg and Y in one glass composition.

It is an object of the invention to provide a new anti-ballistic protection glass.

In particular, it is an object of the invention to provide such a new way of providing antiballistic protection against that overcomes one or more problems encountered with known armour materials, in particular known transparent armour materials.

Further objects which may be solved by the present invention will become apparent from the description below.

It has now been found that a specific glass material is effective in serving as a armour material.

Accordingly, the present invention relates to the use of an oxynitride glass (i.e. a glass comprising oxygen, nitrogen and at least one other component) as an armour material, said glass further comprising yttrium and magnesium cations (as glass network modifying cations).

It has been found that such oxynitride glass has favourable properties as an armour material, in particular as an anti-ballistic material. The incorporated nitrogen is considered to increase the modulus of elasticity (E) and/or the hardness (H) of the material. This contributes to a higher ballistic resistance (Dᵣₑₗ).

The glass used in accordance with the invention is advantageously a monolithic material, rather than a composite material (e.g. with fibres of the glass material in a matrix material). An advantage thereof may be simplicity of manufacture and/or improved transparency.

A further advantage thereof is that a monolithic material can be utilised well in applications wherein transparency is paramount, such as might be the case for optical windows.

Percentages used herein are atom percentages, based on the total number of atoms in the material, unless specified otherwise.

The term transparent as used herein means having the property of transmitting light such that an image can be seen through it as if there was essentially no intervening material, except possibly with the colour biased to that of the material, e.g. as in sunglasses.

The oxynitride used as an armour material usually has a relatively high D-value, when compared to float glass. Preferably the D-value is at least about as high as that of α-alumina. The upper limit of Dᵣₑₗ is not critical and may be up to 3.0 or more.

In particular oxynitrides comprising silica and/or alumina have been found suitable.

The oxynitride glass comprises glass network modifying cations (at least Y³⁺ ions and Mg²⁺ ions). Such cations alter the glass properties, whereby usually the flow and/or melt properties are affected, such that the glass may be processed more easy and/or into more complex shapes than in the absence thereof. The presence of yttrium and magnesium cations is considered advantageous with respect to obtaining a high D-value. These ions are relatively small and possess a relatively high electronegativity. Because of their size and light weight these ions generally result in a less dense glass than when a heavier rare earth is added.

Further, these ions are advantageous with respect to maintaining a high level of transparency.

In particular, the combination of yttrium with magnesium in the glass offers a surprising improvement in a mechanical property and/or density.

A glass (used) according to the invention comprising both yttrium and magnesium offers an advantage, such as improved meltability and/or increased transparency.

The atom to atom ratio of yttrium to magnesium cations is usually at least 1:99. In particular for a high mechanical durability, it is preferably at least 5:95, more preferably at least 10:90.

The atom to atom ratio of yttrium to magnesium cations is usually 99:1 or less, in particular 95:5 or less. In particular for a relatively low density, it is preferably 90:10 or less, more preferably 70:30 or less.

A glass (used) according to the invention contains at least network modifying magnesium and yttrium cations. In principle, the concentration may be relatively low, such as 1 atom % or more. The total concentration of the network modifying yttrium and magnesium cations—in a glass (used) according to the invention, preferably is at least 10 atom %, more preferably at least 13 atom %.

Preferably, the total concentration of the yttrium plus magnesium cations is 20 atom % or less, more preferably 19 atom % or less, in particular 18 atom % or less. In particular, good results have been achieved with a glass having a total yttrium plus magnesium content of about 17 atom % or less.

One or more other network modifying cations, such as calcium and scandium cations may be present, preferably in concentrations as indicated above, wherein preferably the total concentration of network modifying cations is 20 atom % or less.

Particularly suitable additional network modifying cations are (relatively small) trivalent cations of the rare earths such as gadolinium, scandium, terbium and bivalent ions of the alkaline earth metals such as calcium, of which scandium is preferred.

If present, the optional additional network modifying cations may be present in a concentration within a wide range. If present, the total concentration is usually at least 0.01 atom %. Preferably the total concentration of additional network modifying cations is 0-1 atom % Preferably, the concentration of additional network modifying cations is such that the total concentration of network modifying cations is 20 atom % or less.

In principle, terbium may be present as a network modifying cation in an armour glass with desirable transparency. The presence of terbium may result in the glass become luminescent upon exposure to UV light. This may be undesirable if the glass is used in a transport, because it may temporarily reduce transparency, e.g. by the effect of UV light shining on it. It could be a desirable effect in another application. E.g. such effect could serve an aesthetic function.

The invention further relates to an oxynitride glass comprising 3.5 to 15 atom % aluminium, 6 to 10 atom % nitrogen, 10 to 20 atom % silicon, and further yttrium and magnesium cations, wherein the total content of yttrium and magnesium cations is 10-20 atom %, and wherein the ratio of yttrium cations to magnesium cations is preferably such as identified above.

Such glass has been found to have a favourable antiballistic property, in particular a favourable impact resistance property. Accordingly, it is very suitable for use as an armour glass, such as an antiballistic glass.

A glass according to the invention has further been found advantageous with respect to its processability. The liquid phase allows easy formation of curved and complex articles. The glass usually is meltable at a temperature of about 1800° C. or less, in particular at a temperature between 1600° C. and 1800° C.

Thus, the melting temperature is typically lower than the sintering temperature of most transparent ceramics and can be reached with conventional electric furnaces.

The oxynitride glass (used) according to the invention, in particular a glass comprising aluminium, silicon and yttrium plus magnesium usually has a relatively low glass transition temperature, compared to a comparable glass without the network modifying cation. Preferably the glass transition temperature, as determined by ISO 7884-8:1987, is in the range of about 800 to about 1000° C.

A glass (used) according to the invention preferably comprises at least 6 atom % nitrogen. More preferably the nitrogen concentration is at least 7%. Preferably the concentration is up to 10 atom %, in particular up to 9 atom %. A concentration in the range of 6-10 atom % is considered particularly advantageous with respect to a particularly favourable D-value.

The aluminium content preferably is at least 3.5 atom %, more preferably at least 5 atom %, more preferably at least 6 atom %, in particular 7 atom % or more. In view of easy processing of the glass, the aluminium content preferably is 15 atom % or less, more preferably 12 atom % or less. In particular, good results have been achieved with an aluminium content in the range of 7-10 atom %.

The oxynitride glass usually comprises silicon in a concentration of at least 10 atom %, in particular of at least 13 atom %. For easy processing and/or good antiballistic properties, the silicon concentration is preferably 20 atom % or less, in particular 19 atom % or less. More preferably the silicon concentration is 18 atom % or less, in particular about 17 atom % or less.

The balance is essentially fully or predominantly formed of oxygen. Oxygen may in particular be present in a concentration of 50 atom % or more. The oxygen concentration is basically determined by the concentrations of the other components that are present, as will be understood by the skilled person.

In principle, the glass may comprise further components, such as dopants. Such dopants, which are known in the art per se, may serve to alter the appearance of the glass, e.g. to alter the colour or lustre.

In particular for a transparent glass it is preferred that components that may form opaque precipitates in the material, such as iron (typically in the form of an iron oxide) and/or other transition metals are not present in such an amount that clouding of the glass occurs. Therefore, the glass is preferably essentially free of iron and/or other transition metals. In particular, the amount of iron and/or other transition metals is preferably less than 0.5% more preferably less than 0.2%, in case transparency is desired.

The invention further relates to a method for preparing an oxynitride glass, in particular a glass as described above.

Such method comprises

mixing a silicate, an aluminate and/or an alumino-silicate, a nitrogen source and the network modifying cations (i.e. at least magnesium and yttrium) source;

melting said materials, in an inert atmosphere, thereby forming a melt;

optionally shaping the melt; and

allowing the melt to solidify.

Shaping and solidification are usually also carried out in an inert atmosphere; mixing usually only needs to be carried out in an inert atmosphere in case it takes place while the raw materials are molten. An inert atmosphere is an atmosphere that does not contain oxygen in a concentration that leads to substantial formation of oxide glass rather than oxynitride glass, due to a reaction of the nitrogen with oxygen at elevated temperatures. Therefore, the oxygen concentration in the atmosphere is preferably 0.1 mol % or less, in particular 0.01 mol % or less, more in particular 0.001 mol % or less. Preferably, the inert atmosphere essentially consists of nitrogen, a noble gas or a combination thereof. It is in particular preferred that the atmosphere comprises nitrogen, as its presence suppresses decomposition of the nitrides.

As a nitride source, in principle any (oxy)nitride or mixture of (oxy)nitrides may be used, in particular at least one (oxy)nitride selected from AlN, Si₃N₄ and AlON.

As a source for the network modifying cation, oxides of the component are in particular suitable. Other sources, such as a carbonate of the component, may be used.

In case one or more of the raw materials contain a considerable amount of iron and/or one or more other transition metals, the material may be refined to reduce the content of the transition metal(s). This may be done by means known in the art.

The preparation of the glass is preferably carried out at a temperature of about 1800° C. or less, with the proviso that the melting is carried out at a temperature at which also the highest melting component fully melts.

The materials are preferably mixed prior to melting. Mixing may suitably be performed by mechanical agitation (e.g. using a ball mill and/or an attritor mill).

In an embodiment the materials are dispersed in a dispersing medium, for instance an alcohol, in particular isopropanol.

The resulting slurry may be dried and compacted via isostatic and/or uni-axial pressing.

The mixture (such as the dried slurry) may thereafter be placed in a crucible. The crucible usually comprises an open pot made of a refractory material (such as graphite), which, on the inside, may be lined with a layer of hexagonal-boron nitride powder or another lining that helps to prevent the glass from sticking to the crucible during melting. The boron nitride is a preferred powder because the boron nitride has been found essentially not to react with (or incorporate in) the molten glass.

The (compacted) mixture may then be heated to form a homogenous melt.

The melting is preferably carried out at a temperature in the range of about 1600-1800° C. A melting time of about 0.5-2 hours is usually sufficient, although melting may be performed for a shorter or longer duration.

The melt may then be shaped. Shaping can be done by a conventional glass working technique, such as by casting.

After solidification, the glass may be further treated. Such treatment may be carried out under an inert atmosphere, although that is not necessary.

After solidification, the glass is preferably annealed. Annealing may be carried out under an oxygen containing atmosphere such as air. This may lead to the formation of a thin oxide scale, which may be removed afterwards. For this reason, annealing is preferably carried out in an inert atmosphere.

The invention further relates to a glass article made of a oxynitride glass as described herein, in particular a glass article obtainable by a method according to the invention.

In an embodiment, the glass article comprises at least one curved surface. Such article may favourably made by a method of the invention.

In an advantageous embodiment the glass article is monolithic, rather than a composite material.

In particular, the glass article may be selected from the group consisting of windows, screens, canopies and domes.

In a preferred embodiment the glass article is a laminate of at least one layer of a glass as described herein and at least one polymer layer. Such polymer layer may serve as a backing. When in use, the polymer layer is usually present at a surface of the glass layer opposite to the one from which the impact is expected. The backing thus serves to suppress breaking of the glass and/or spreading of glass shards upon impact by a projectile.

Suitable backings include layers of polymers, such as a polycarbonate or a polyurethane. It will be understood that in case, the article should be transparent, a polymer layer that is transparent should be used.

In an embodiment, the article is a laminate comprising a plurality of alternating layers of the glass and the polymer.

The invention further relates to a transport or a counter comprising a glass article according to the invention. In particular the transport may be selected from cars, buses, aircraft (planes, helicopters) and boats.

In a further aspect the present invention relates to the use of an oxynitride glass comprising a glass network modifying cation as an armour material wherein the oxynitride glass comprises aluminium, silicon and at least one network modifying cation selected from the group consisting of cations of yttrium, magnesium, calcium, terbium, gadolinium and scandium, preferably yttrium, wherein in total 10 to 20 atom %, based on the total number of atoms in the material, of the network modifying cation or cations; and preferably the nitrogen content is in the range of 6 to 10 atom %, in particular 7 to 10 atom %, based on the total number of atoms in the material.

The invention will now be illustrated by the following example.

### EXAMPLE

A starting powder was made from Si₃N₄, SiO₂, Y₂O₃, Al₂O₃ and MgO. The raw oxides and nitrides were weighed-out to yield the following amounts: 15 parts Mg, 1.6 parts Y, 6.6 parts Al, 53.1 parts 0, 6.2 parts N and 17.5 parts Si.

A slurry was formed by adding approximately one part of isopropanol to one part of powder. The slurry was mixed on a roller bank ball mill using Si₃N₄ balls during a period of 12 hrs. The slurry heated under continuous stirring on an electric heater, until all isopropanol had evaporated. Further drying was performed in an oven at 80° C. The dried slurry was isostatically pressed at 2500 bar. The compacted material was placed in a crucible comprising an open pot made of a refractory material (mullite), which, on the inside, was lined with a layer of hexagonal-boron nitride powder.

The compacted material and crucible were heated to a temperature of 1600° C. in a furnace to achieve a homogeneous melt. Melting was performed in an inert atmosphere (nitrogen). After the formation of the homogeneous melt the crucible with molten contents was taken out of the furnace for and annealed for 1 hour at 900° C. in air.

The resulting oxynitride glass was determined to posses the following properties.

| | ρ | H* | E | K_{Ic} | Dᵣₑₗ* |
|---|---|---|---|---|---|
| Material | g/cm³ | GPa | GPa | MPa · m^{0.5} | — |
| Mg—Y—Si—Al—O—N | 2.93 | 7.8 | 143 | 1.08 | 2.15 |
| float glass | 2.5 | 5.0 | 73.4 | 0.8 | 1.0 |

*Vickers, 1 N

It is clear from the table that the Mg—Y—Si—Al—O—N glass has a higher ballistic resistance than the standard float glass.

Surprisingly the D-value for the mixed glasses is of the same magnitude as Y—Si—Al—O—N glasses (typical values 2.0-2.4), while the density is considerably lower (typical values Y—Si—Al—O—N glasses 3.6-4.1 gm/cm³). From this it is concluded that the Mg—Y—Si—Al—O—N glass of the invention offers an improved ballistic resistance at the same weight or a similar or better ballistic resistance as the Y—Si—Al—O—N glasses at a reduced weight.

The invention relates to the use of an oxynitride glass as an armour material. The invention further relates to a novel oxynitride glass.

Armour materials, in particular materials used as an anti-ballistic material need to have a high resistance against high velocity impact against bullets and/or other missiles. An indicative value to judge such resistance is the D-value, which can be calculated with the following formula:

$$D = \frac{H * E}{{K}_{Ic}^{2}} * \sqrt{\frac{E}{ρ}}$$

wherein:

H=hardness in GPa

K_{Ic}=fracture toughness in MPa·m^{1/2}

E=Young's modulus in GPa

ρ=density in g/cm³

The higher the D-value the better the impact resistance. In order to get an indication of the suitability of a material as an armour material, one may determine Dᵣₑₗ which is the ratio of the D-value of the material and the D-value of float glass. Thus, Dᵣₑₗ for float glass is 1.0. For example, polycrystalline α-aluminium oxide, may have a Dᵣₑₗ of about 1.9, which makes it a suitable armour material. YAG (Y₃Al₅O₁₂) has a Dᵣₑₗ of only about 1.0, whereby its performance is not better than float glass.

Transparent armour articles may be made of transparent glass or transparent ceramics. Such materials find use in e.g. transports such as cars, aircraft and boats, and in counters, boots and the like.

Known armour glasses are suitable to protect against relatively light ammunition. In order to be effective against heavier ammunition, the material needs to be thicker. Depending on the type of threat, armour glasses need to have thicknesses ranging from 5 cm to 20 cm. The dimensions and the resulting weight of these articles make the material generally undesirable and in particular unacceptable for use in helicopters and other aircraft.

Ceramic armour materials tend to be much stronger than conventional glass materials and can therefore be made into thinner articles. However, ceramic armour materials are usually more difficult to form into transparent articles of a complex shape (such as curved shapes) or large articles than armour glasses. As a result, a transparent ceramic armour tends to be very expensive.

Donald R. Messier (American Ceramic Society Bulletin, 68 (1989) November, No 11, p 1931-1936) refers to M-Si—Al—O—N glass materials (M being one of Ca, Li, Mg or Y). The use of oxynitride glasses for use in transparent armour and glass fibres for resin-matrix composites is suggested. It is not suggested to use a specific combination of Ca, Li, Mg and Y, let alone of Mg and Y in one glass composition.

It is an object of the invention to provide a new anti-ballistic protection glass.

In particular, it is an object of the invention to provide such a new way of providing antiballistic protection against that overcomes one or more problems encountered with known armour materials, in particular known transparent armour materials.

Further objects which may be solved by the present invention will become apparent from the description below.

It has now been found that a specific glass material is effective in serving as a armour material.

Accordingly, the present invention relates to the use of an oxynitride glass (i.e. a glass comprising oxygen, nitrogen and at least one other component) as an armour material, said glass further comprising yttrium and magnesium cations (as glass network modifying cations).

It has been found that such oxynitride glass has favourable properties as an armour material, in particular as an anti-ballistic material. The incorporated nitrogen is considered to increase the modulus of elasticity (E) and/or the hardness (H) of the material. This contributes to a higher ballistic resistance (Dᵣₑₗ).

The glass used in accordance with the invention is advantageously a monolithic material, rather than a composite material (e.g. with fibres of the glass material in a matrix material). An advantage thereof may be simplicity of manufacture and/or improved transparency.

A further advantage thereof is that a monolithic material can be utilised well in applications wherein transparency is paramount, such as might be the case for optical windows.

Percentages used herein are atom percentages, based on the total number of atoms in the material, unless specified otherwise.

The term transparent as used herein means having the property of transmitting light such that an image can be seen through it as if there was essentially no intervening material, except possibly with the colour biased to that of the material, e.g. as in sunglasses.

The oxynitride used as an armour material usually has a relatively high D-value, when compared to float glass. Preferably the D-value is at least about as high as that of α-alumina. The upper limit of Dᵣₑₗ is not critical and may be up to 3.0 or more.

In particular oxynitrides comprising silica and/or alumina have been found suitable.

The oxynitride glass comprises glass network modifying cations (at least Y³⁺ ions and Mg²⁺ ions). Such cations alter the glass properties, whereby usually the flow and/or melt properties are affected, such that the glass may be processed more easy and/or into more complex shapes than in the absence thereof. The presence of yttrium and magnesium cations is considered advantageous with respect to obtaining a high D-value. These ions are relatively small and possess a relatively high electronegativity. Because of their size and light weight these ions generally result in a less dense glass than when a heavier rare earth is added.

Further, these ions are advantageous with respect to maintaining a high level of transparency.

In particular, the combination of yttrium with magnesium in the glass offers a surprising improvement in a mechanical property and/or density.

A glass (used) according to the invention comprising both yttrium and magnesium offers an advantage, such as improved meltability and/or increased transparency.

The atom to atom ratio of yttrium to magnesium cations is usually at least 1:99. In particular for a high mechanical durability, it is preferably at least 5:95, more preferably at least 10:90.

The atom to atom ratio of yttrium to magnesium cations is usually 99:1 or less, in particular 95:5 or less. In particular for a relatively low density, it is preferably 90:10 or less, more preferably 70:30 or less.

A glass (used) according to the invention contains at least network modifying magnesium and yttrium cations. In principle, the concentration may be relatively low, such as 1 atom % or more. The total concentration of the network modifying yttrium and magnesium cations—in a glass (used) according to the invention, preferably is at least 10 atom %, more preferably at least 13 atom %.

Preferably, the total concentration of the yttrium plus magnesium cations is 20 atom % or less, more preferably 19 atom % or less, in particular 18 atom % or less. In particular, good results have been achieved with a glass having a total yttrium plus magnesium content of about 17 atom % or less.

One or more other network modifying cations, such as calcium and scandium cations may be present, preferably in concentrations as indicated above, wherein preferably the total concentration of network modifying cations is 20 atom % or less.

Particularly suitable additional network modifying cations are (relatively small) trivalent cations of the rare earths such as gadolinium, scandium, terbium and bivalent ions of the alkaline earth metals such as calcium, of which scandium is preferred.

If present, the optional additional network modifying cations may be present in a concentration within a wide range. If present, the total concentration is usually at least 0.01 atom %. Preferably the total concentration of additional network modifying cations is 0-1 atom % Preferably, the concentration of additional network modifying cations is such that the total concentration of network modifying cations is 20 atom % or less.

In principle, terbium may be present as a network modifying cation in an armour glass with desirable transparency. The presence of terbium may result in the glass become luminescent upon exposure to UV light. This may be undesirable if the glass is used in a transport, because it may temporarily reduce transparency, e.g. by the effect of UV light shining on it. It could be a desirable effect in another application. E.g. such effect could serve an aesthetic function.

The invention further relates to an oxynitride glass comprising 3.5 to 15 atom % aluminium, 6 to 10 atom % nitrogen, 10 to 20 atom % silicon, and further yttrium and magnesium cations, wherein the total content of yttrium and magnesium cations is 10-20 atom %, and wherein the ratio of yttrium cations to magnesium cations is preferably such as identified above.

Such glass has been found to have a favourable antiballistic property, in particular a favourable impact resistance property. Accordingly, it is very suitable for use as an armour glass, such as an antiballistic glass.

A glass according to the invention has further been found advantageous with respect to its processability. The liquid phase allows easy formation of curved and complex articles. The glass usually is meltable at a temperature of about 1800° C. or less, in particular at a temperature between 1600° C. and 1800° C.

Thus, the melting temperature is typically lower than the sintering temperature of most transparent ceramics and can be reached with conventional electric furnaces.

The oxynitride glass (used) according to the invention, in particular a glass comprising aluminium, silicon and yttrium plus magnesium usually has a relatively low glass transition temperature, compared to a comparable glass without the network modifying cation. Preferably the glass transition temperature, as determined by ISO 7884-8:1987, is in the range of about 800 to about 1000° C.

A glass (used) according to the invention preferably comprises at least 6 atom % nitrogen. More preferably the nitrogen concentration is at least 7%. Preferably the concentration is up to 10 atom %, in particular up to 9 atom %. A concentration in the range of 6-10 atom % is considered particularly advantageous with respect to a particularly favourable D-value.

The aluminium content preferably is at least 3.5 atom %, more preferably at least 5 atom %, more preferably at least 6 atom %, in particular 7 atom % or more. In view of easy processing of the glass, the aluminium content preferably is 15 atom % or less, more preferably 12 atom % or less. In particular, good results have been achieved with an aluminium content in the range of 7-10 atom %.

The oxynitride glass usually comprises silicon in a concentration of at least 10 atom %, in particular of at least 13 atom %. For easy processing and/or good antiballistic properties, the silicon concentration is preferably 20 atom % or less, in particular 19 atom % or less. More preferably the silicon concentration is 18 atom % or less, in particular about 17 atom % or less.

The balance is essentially fully or predominantly formed of oxygen. Oxygen may in particular be present in a concentration of 50 atom % or more. The oxygen concentration is basically determined by the concentrations of the other components that are present, as will be understood by the skilled person.

In principle, the glass may comprise further components, such as dopants. Such dopants, which are known in the art per se, may serve to alter the appearance of the glass, e.g. to alter the colour or lustre.

In particular for a transparent glass it is preferred that components that may form opaque precipitates in the material, such as iron (typically in the form of an iron oxide) and/or other transition metals are not present in such an amount that clouding of the glass occurs. Therefore, the glass is preferably essentially free of iron and/or other transition metals. In particular, the amount of iron and/or other transition metals is preferably less than 0.5% more preferably less than 0.2%, in case transparency is desired.

The invention further relates to a method for preparing an oxynitride glass, in particular a glass as described above.

Such method comprises

mixing a silicate, an aluminate and/or an alumino-silicate, a nitrogen source and the network modifying cations (i.e. at least magnesium and yttrium) source;

melting said materials, in an inert atmosphere, thereby forming a melt;

optionally shaping the melt; and

allowing the melt to solidify.

Shaping and solidification are usually also carried out in an inert atmosphere; mixing usually only needs to be carried out in an inert atmosphere in case it takes place while the raw materials are molten. An inert atmosphere is an atmosphere that does not contain oxygen in a concentration that leads to substantial formation of oxide glass rather than oxynitride glass, due to a reaction of the nitrogen with oxygen at elevated temperatures. Therefore, the oxygen concentration in the atmosphere is preferably 0.1 mol % or less, in particular 0.01 mol % or less, more in particular 0.001 mol % or less. Preferably, the inert atmosphere essentially consists of nitrogen, a noble gas or a combination thereof. It is in particular preferred that the atmosphere comprises nitrogen, as its presence suppresses decomposition of the nitrides.

As a nitride source, in principle any (oxy)nitride or mixture of (oxy)nitrides may be used, in particular at least one (oxy)nitride selected from AlN, Si₃N₄ and AlON.

As a source for the network modifying cation, oxides of the component are in particular suitable. Other sources, such as a carbonate of the component, may be used.

In case one or more of the raw materials contain a considerable amount of iron and/or one or more other transition metals, the material may be refined to reduce the content of the transition metal(s). This may be done by means known in the art.

The preparation of the glass is preferably carried out at a temperature of about 1800° C. or less, with the proviso that the melting is carried out at a temperature at which also the highest melting component fully melts.

The materials are preferably mixed prior to melting. Mixing may suitably be performed by mechanical agitation (e.g. using a ball mill and/or an attritor mill).

In an embodiment the materials are dispersed in a dispersing medium, for instance an alcohol, in particular isopropanol.

The resulting slurry may be dried and compacted via isostatic and/or uni-axial pressing.

The mixture (such as the dried slurry) may thereafter be placed in a crucible. The crucible usually comprises an open pot made of a refractory material (such as graphite), which, on the inside, may be lined with a layer of hexagonal-boron nitride powder or another lining that helps to prevent the glass from sticking to the crucible during melting. The boron nitride is a preferred powder because the boron nitride has been found essentially not to react with (or incorporate in) the molten glass.

The (compacted) mixture may then be heated to form a homogenous melt.

The melting is preferably carried out at a temperature in the range of about 1600-1800° C. A melting time of about 0.5-2 hours is usually sufficient, although melting may be performed for a shorter or longer duration.

The melt may then be shaped. Shaping can be done by a conventional glass working technique, such as by casting.

After solidification, the glass may be further treated. Such treatment may be carried out under an inert atmosphere, although that is not necessary.

After solidification, the glass is preferably annealed. Annealing may be carried out under an oxygen containing atmosphere such as air. This may lead to the formation of a thin oxide scale, which may be removed afterwards. For this reason, annealing is preferably carried out in an inert atmosphere.

The invention further relates to a glass article made of a oxynitride glass as described herein, in particular a glass article obtainable by a method according to the invention.

In an embodiment, the glass article comprises at least one curved surface. Such article may favourably made by a method of the invention.

In an advantageous embodiment the glass article is monolithic, rather than a composite material.

In particular, the glass article may be selected from the group consisting of windows, screens, canopies and domes.

In a preferred embodiment the glass article is a laminate of at least one layer of a glass as described herein and at least one polymer layer. Such polymer layer may serve as a backing. When in use, the polymer layer is usually present at a surface of the glass layer opposite to the one from which the impact is expected. The backing thus serves to suppress breaking of the glass and/or spreading of glass shards upon impact by a projectile.

Suitable backings include layers of polymers, such as a polycarbonate or a polyurethane. It will be understood that in case, the article should be transparent, a polymer layer that is transparent should be used.

In an embodiment, the article is a laminate comprising a plurality of alternating layers of the glass and the polymer.

The invention further relates to a transport or a counter comprising a glass article according to the invention. In particular the transport may be selected from cars, buses, aircraft (planes, helicopters) and boats.

In a further aspect the present invention relates to the use of an oxynitride glass comprising a glass network modifying cation as an armour material wherein the oxynitride glass comprises aluminium, silicon and at least one network modifying cation selected from the group consisting of cations of yttrium, magnesium, calcium, terbium, gadolinium and scandium, preferably yttrium, wherein in total 10 to 20 atom %, based on the total number of atoms in the material, of the network modifying cation or cations; and preferably the nitrogen content is in the range of 6 to 10 atom %, in particular 7 to 10 atom %, based on the total number of atoms in the material.

The invention will now be illustrated by the following example.

### Example

A starting powder was made from Si₃N₄, SiO₂, Y₂O₃, Al₂O₃ and MgO. The raw oxides and nitrides were weighed-out to yield the following amounts: 15 parts Mg, 1.6 parts Y, 6.6 parts Al, 53.1 parts 0, 6.2 parts N and 17.5 parts Si.

A slurry was formed by adding approximately one part of isopropanol to one part of powder. The slurry was mixed on a roller bank ball mill using Si₃N₄ balls during a period of 12 hrs. The slurry heated under continuous stirring on an electric heater, until all isopropanol had evaporated. Further drying was performed in an oven at 80° C. The dried slurry was isostatically pressed at 2500 bar. The compacted material was placed in a crucible comprising an open pot made of a refractory material (mullite), which, on the inside, was lined with a layer of hexagonal-boron nitride powder.

The compacted material and crucible were heated to a temperature of 1600° C. in a furnace to achieve a homogeneous melt. Melting was performed in an inert atmosphere (nitrogen). After the formation of the homogeneous melt the crucible with molten contents was taken out of the furnace for and annealed for 1 hour at 900° C. in air.

The resulting oxynitride glass was determined to posses the following properties.

| | ρ | H* | E | K_{Ic} | Dᵣₑₗ* |
|---|---|---|---|---|---|
| Material | g/cm³ | GPa | GPa | MPa · m^{0.5} | — |
| Mg—Y—Si—Al—O—N | 2.93 | 7.8 | 143 | 1.08 | 2.15 |
| float glass | 2.5 | 5.0 | 73.4 | 0.8 | 1.0 |

*Vickers, 1 N

It is clear from the table that the Mg—Y—Si—Al—O—N glass has a higher ballistic resistance than the standard float glass.

Surprisingly the D-value for the mixed glasses is of the same magnitude as Y—Si—Al—O—N glasses (typical values 2.0-2.4), while the density is considerably lower (typical values Y—Si—Al—O—N glasses 3.6-4.1 gm/cm³). From this it is concluded that the Mg—Y—Si—Al—O—N glass of the invention offers an improved ballistic resistance at the same weight or a similar or better ballistic resistance as the Y—Si—Al—O—N glasses at a reduced weight.

The invention relates to the use of an oxynitride glass as an armour material. The invention further relates to a novel oxynitride glass.

Armour materials, in particular materials used as an anti-ballistic material need to have a high resistance against high velocity impact against bullets and/or other missiles. An indicative value to judge such resistance is the D-value, which can be calculated with the following formula:

$$D = \frac{H * E}{{K}_{Ic}^{2}} * \sqrt{\frac{E}{ρ}}$$

wherein:

H=hardness in GPa

K_{Ic}=fracture toughness in MPa·m^{1/2}

E=Young's modulus in GPa

ρ=density in g/cm³

The higher the D-value the better the impact resistance. In order to get an indication of the suitability of a material as an armour material, one may determine Dᵣₑₗ which is the ratio of the D-value of the material and the D-value of float glass. Thus, Dᵣₑₗ for float glass is 1.0. For example, polycrystalline α-aluminium oxide, may have a Dᵣₑₗ of about 1.9, which makes it a suitable armour material. YAG (Y₃Al₅O₁₂) has a Dᵣₑₗ of only about 1.0, whereby its performance is not better than float glass.

Transparent armour articles may be made of transparent glass or transparent ceramics. Such materials find use in e.g. transports such as cars, aircraft and boats, and in counters, boots and the like.

Known armour glasses are suitable to protect against relatively light ammunition. In order to be effective against heavier ammunition, the material needs to be thicker. Depending on the type of threat, armour glasses need to have thicknesses ranging from 5 cm to 20 cm. The dimensions and the resulting weight of these articles make the material generally undesirable and in particular unacceptable for use in helicopters and other aircraft.

Ceramic armour materials tend to be much stronger than conventional glass materials and can therefore be made into thinner articles. However, ceramic armour materials are usually more difficult to form into transparent articles of a complex shape (such as curved shapes) or large articles than armour glasses. As a result, a transparent ceramic armour tends to be very expensive.

Donald R. Messier (American Ceramic Society Bulletin, 68 (1989) November, No 11, p 1931-1936) refers to M-Si—Al—O—N glass materials (M being one of Ca, Li, Mg or Y). The use of oxynitride glasses for use in transparent armour and glass fibres for resin-matrix composites is suggested. It is not suggested to use a specific combination of Ca, Li, Mg and Y, let alone of Mg and Y in one glass composition.

It is an object of the invention to provide a new anti-ballistic protection glass.

In particular, it is an object of the invention to provide such a new way of providing antiballistic protection against that overcomes one or more problems encountered with known armour materials, in particular known transparent armour materials.

Further objects which may be solved by the present invention will become apparent from the description below.

It has now been found that a specific glass material is effective in serving as a armour material.

Accordingly, the present invention relates to the use of an oxynitride glass (i.e. a glass comprising oxygen, nitrogen and at least one other component) as an armour material, said glass further comprising yttrium and magnesium cations (as glass network modifying cations).

It has been found that such oxynitride glass has favourable properties as an armour material, in particular as an anti-ballistic material. The incorporated nitrogen is considered to increase the modulus of elasticity (E) and/or the hardness (H) of the material. This contributes to a higher ballistic resistance (Dᵣₑₗ).

The glass used in accordance with the invention is advantageously a monolithic material, rather than a composite material (e.g. with fibres of the glass material in a matrix material). An advantage thereof may be simplicity of manufacture and/or improved transparency.

A further advantage thereof is that a monolithic material can be utilised well in applications wherein transparency is paramount, such as might be the case for optical windows.

Percentages used herein are atom percentages, based on the total number of atoms in the material, unless specified otherwise.

The term transparent as used herein means having the property of transmitting light such that an image can be seen through it as if there was essentially no intervening material, except possibly with the colour biased to that of the material, e.g. as in sunglasses.

The oxynitride used as an armour material usually has a relatively high D-value, when compared to float glass. Preferably the D-value is at least about as high as that of α-alumina. The upper limit of Dᵣₑₗ is not critical and may be up to 3.0 or more.

In particular oxynitrides comprising silica and/or alumina have been found suitable.

The oxynitride glass comprises glass network modifying cations (at least Y³⁺ ions and Mg²⁺ ions). Such cations alter the glass properties, whereby usually the flow and/or melt properties are affected, such that the glass may be processed more easy and/or into more complex shapes than in the absence thereof. The presence of yttrium and magnesium cations is considered advantageous with respect to obtaining a high D-value. These ions are relatively small and possess a relatively high electronegativity. Because of their size and light weight these ions generally result in a less dense glass than when a heavier rare earth is added.

Further, these ions are advantageous with respect to maintaining a high level of transparency.

In particular, the combination of yttrium with magnesium in the glass offers a surprising improvement in a mechanical property and/or density.

A glass (used) according to the invention comprising both yttrium and magnesium offers an advantage, such as improved meltability and/or increased transparency.

The atom to atom ratio of yttrium to magnesium cations is usually at least 1:99. In particular for a high mechanical durability, it is preferably at least 5:95, more preferably at least 10:90.

The atom to atom ratio of yttrium to magnesium cations is usually 99:1 or less, in particular 95:5 or less. In particular for a relatively low density, it is preferably 90:10 or less, more preferably 70:30 or less.

A glass (used) according to the invention contains at least network modifying magnesium and yttrium cations. In principle, the concentration may be relatively low, such as 1 atom % or more. The total concentration of the network modifying yttrium and magnesium cations—in a glass (used) according to the invention, preferably is at least 10 atom %, more preferably at least 13 atom %.

Preferably, the total concentration of the yttrium plus magnesium cations is 20 atom % or less, more preferably 19 atom % or less, in particular 18 atom % or less. In particular, good results have been achieved with a glass having a total yttrium plus magnesium content of about 17 atom % or less.

One or more other network modifying cations, such as calcium and scandium cations may be present, preferably in concentrations as indicated above, wherein preferably the total concentration of network modifying cations is 20 atom % or less.

Particularly suitable additional network modifying cations are (relatively small) trivalent cations of the rare earths such as gadolinium, scandium, terbium and bivalent ions of the alkaline earth metals such as calcium, of which scandium is preferred.

If present, the optional additional network modifying cations may be present in a concentration within a wide range. If present, the total concentration is usually at least 0.01 atom %. Preferably the total concentration of additional network modifying cations is 0-1 atom % Preferably, the concentration of additional network modifying cations is such that the total concentration of network modifying cations is 20 atom % or less.

In principle, terbium may be present as a network modifying cation in an armour glass with desirable transparency. The presence of terbium may result in the glass become luminescent upon exposure to UV light. This may be undesirable if the glass is used in a transport, because it may temporarily reduce transparency, e.g. by the effect of UV light shining on it. It could be a desirable effect in another application. E.g. such effect could serve an aesthetic function.

The invention further relates to an oxynitride glass comprising 3.5 to 15 atom % aluminium, 6 to 10 atom % nitrogen, 10 to 20 atom % silicon, and further yttrium and magnesium cations, wherein the total content of yttrium and magnesium cations is 10-20 atom %, and wherein the ratio of yttrium cations to magnesium cations is preferably such as identified above.

Such glass has been found to have a favourable antiballistic property, in particular a favourable impact resistance property. Accordingly, it is very suitable for use as an armour glass, such as an antiballistic glass.

A glass according to the invention has further been found advantageous with respect to its processability. The liquid phase allows easy formation of curved and complex articles. The glass usually is meltable at a temperature of about 1800° C. or less, in particular at a temperature between 1600° C. and 1800° C.

Thus, the melting temperature is typically lower than the sintering temperature of most transparent ceramics and can be reached with conventional electric furnaces.

The oxynitride glass (used) according to the invention, in particular a glass comprising aluminium, silicon and yttrium plus magnesium usually has a relatively low glass transition temperature, compared to a comparable glass without the network modifying cation. Preferably the glass transition temperature, as determined by ISO 7884-8:1987, is in the range of about 800 to about 1000° C.

A glass (used) according to the invention preferably comprises at least 6 atom % nitrogen. More preferably the nitrogen concentration is at least 7%. Preferably the concentration is up to 10 atom %, in particular up to 9 atom %. A concentration in the range of 6-10 atom % is considered particularly advantageous with respect to a particularly favourable D-value.

The aluminium content preferably is at least 3.5 atom %, more preferably at least 5 atom %, more preferably at least 6 atom %, in particular 7 atom % or more. In view of easy processing of the glass, the aluminium content preferably is 15 atom % or less, more preferably 12 atom % or less. In particular, good results have been achieved with an aluminium content in the range of 7-10 atom %.

The oxynitride glass usually comprises silicon in a concentration of at least 10 atom %, in particular of at least 13 atom %. For easy processing and/or good antiballistic properties, the silicon concentration is preferably 20 atom % or less, in particular 19 atom % or less. More preferably the silicon concentration is 18 atom % or less, in particular about 17 atom % or less.

The balance is essentially fully or predominantly formed of oxygen. Oxygen may in particular be present in a concentration of 50 atom % or more. The oxygen concentration is basically determined by the concentrations of the other components that are present, as will be understood by the skilled person.

In principle, the glass may comprise further components, such as dopants. Such dopants, which are known in the art per se, may serve to alter the appearance of the glass, e.g. to alter the colour or lustre.

In particular for a transparent glass it is preferred that components that may form opaque precipitates in the material, such as iron (typically in the form of an iron oxide) and/or other transition metals are not present in such an amount that clouding of the glass occurs. Therefore, the glass is preferably essentially free of iron and/or other transition metals. In particular, the amount of iron and/or other transition metals is preferably less than 0.5% more preferably less than 0.2%, in case transparency is desired.

The invention further relates to a method for preparing an oxynitride glass, in particular a glass as described above.

Such method comprises

mixing a silicate, an aluminate and/or an alumino-silicate, a nitrogen source and the network modifying cations (i.e. at least magnesium and yttrium) source;

melting said materials, in an inert atmosphere, thereby forming a melt;

optionally shaping the melt; and

allowing the melt to solidify.

Shaping and solidification are usually also carried out in an inert atmosphere; mixing usually only needs to be carried out in an inert atmosphere in case it takes place while the raw materials are molten. An inert atmosphere is an atmosphere that does not contain oxygen in a concentration that leads to substantial formation of oxide glass rather than oxynitride glass, due to a reaction of the nitrogen with oxygen at elevated temperatures. Therefore, the oxygen concentration in the atmosphere is preferably 0.1 mol % or less, in particular 0.01 mol % or less, more in particular 0.001 mol % or less. Preferably, the inert atmosphere essentially consists of nitrogen, a noble gas or a combination thereof. It is in particular preferred that the atmosphere comprises nitrogen, as its presence suppresses decomposition of the nitrides.

As a nitride source, in principle any (oxy)nitride or mixture of (oxy)nitrides may be used, in particular at least one (oxy)nitride selected from AlN, Si₃N₄ and AlON.

As a source for the network modifying cation, oxides of the component are in particular suitable. Other sources, such as a carbonate of the component, may be used.

In case one or more of the raw materials contain a considerable amount of iron and/or one or more other transition metals, the material may be refined to reduce the content of the transition metal(s). This may be done by means known in the art.

The preparation of the glass is preferably carried out at a temperature of about 1800° C. or less, with the proviso that the melting is carried out at a temperature at which also the highest melting component fully melts.

The materials are preferably mixed prior to melting. Mixing may suitably be performed by mechanical agitation (e.g. using a ball mill and/or an attritor mill).

In an embodiment the materials are dispersed in a dispersing medium, for instance an alcohol, in particular isopropanol.

The resulting slurry may be dried and compacted via isostatic and/or uni-axial pressing.

The mixture (such as the dried slurry) may thereafter be placed in a crucible. The crucible usually comprises an open pot made of a refractory material (such as graphite), which, on the inside, may be lined with a layer of hexagonal-boron nitride powder or another lining that helps to prevent the glass from sticking to the crucible during melting. The boron nitride is a preferred powder because the boron nitride has been found essentially not to react with (or incorporate in) the molten glass.

The (compacted) mixture may then be heated to form a homogenous melt.

The melting is preferably carried out at a temperature in the range of about 1600-1800° C. A melting time of about 0.5-2 hours is usually sufficient, although melting may be performed for a shorter or longer duration.

The melt may then be shaped. Shaping can be done by a conventional glass working technique, such as by casting.

After solidification, the glass may be further treated. Such treatment may be carried out under an inert atmosphere, although that is not necessary.

After solidification, the glass is preferably annealed. Annealing may be carried out under an oxygen containing atmosphere such as air. This may lead to the formation of a thin oxide scale, which may be removed afterwards. For this reason, annealing is preferably carried out in an inert atmosphere.

The invention further relates to a glass article made of a oxynitride glass as described herein, in particular a glass article obtainable by a method according to the invention.

In an embodiment, the glass article comprises at least one curved surface. Such article may favourably made by a method of the invention.

In an advantageous embodiment the glass article is monolithic, rather than a composite material.

In particular, the glass article may be selected from the group consisting of windows, screens, canopies and domes.

In a preferred embodiment the glass article is a laminate of at least one layer of a glass as described herein and at least one polymer layer. Such polymer layer may serve as a backing. When in use, the polymer layer is usually present at a surface of the glass layer opposite to the one from which the impact is expected. The backing thus serves to suppress breaking of the glass and/or spreading of glass shards upon impact by a projectile.

Suitable backings include layers of polymers, such as a polycarbonate or a polyurethane. It will be understood that in case, the article should be transparent, a polymer layer that is transparent should be used.

In an embodiment, the article is a laminate comprising a plurality of alternating layers of the glass and the polymer.

The invention further relates to a transport or a counter comprising a glass article according to the invention. In particular the transport may be selected from cars, buses, aircraft (planes, helicopters) and boats.

In a further aspect the present invention relates to the use of an oxynitride glass comprising a glass network modifying cation as an armour material wherein the oxynitride glass comprises aluminium, silicon and at least one network modifying cation selected from the group consisting of cations of yttrium, magnesium, calcium, terbium, gadolinium and scandium, preferably yttrium, wherein in total 10 to 20 atom %, based on the total number of atoms in the material, of the network modifying cation or cations; and preferably the nitrogen content is in the range of 6 to 10 atom %, in particular 7 to 10 atom %, based on the total number of atoms in the material.

The invention will now be illustrated by the following example.

### Example

A starting powder was made from Si₃N₄, SiO₂, Y₂O₃, Al₂O₃ and MgO. The raw oxides and nitrides were weighed-out to yield the following amounts: 15 parts Mg, 1.6 parts Y, 6.6 parts Al, 53.1 parts 0, 6.2 parts N and 17.5 parts Si.

A slurry was formed by adding approximately one part of isopropanol to one part of powder. The slurry was mixed on a roller bank ball mill using Si₃N₄ balls during a period of 12 hrs. The slurry heated under continuous stirring on an electric heater, until all isopropanol had evaporated. Further drying was performed in an oven at 80° C. The dried slurry was isostatically pressed at 2500 bar. The compacted material was placed in a crucible comprising an open pot made of a refractory material (mullite), which, on the inside, was lined with a layer of hexagonal-boron nitride powder.

The compacted material and crucible were heated to a temperature of 1600° C. in a furnace to achieve a homogeneous melt. Melting was performed in an inert atmosphere (nitrogen). After the formation of the homogeneous melt the crucible with molten contents was taken out of the furnace for and annealed for 1 hour at 900° C. in air.

The resulting oxynitride glass was determined to posses the following properties.

| | ρ | H* | E | K_{Ic} | Dᵣₑₗ* |
|---|---|---|---|---|---|
| Material | g/cm³ | GPa | GPa | MPa · m^{0.5} | — |
| Mg—Y—Si—Al—O—N | 2.93 | 7.8 | 143 | 1.08 | 2.15 |
| float glass | 2.5 | 5.0 | 73.4 | 0.8 | 1.0 |

*Vickers, 1 N

It is clear from the table that the Mg—Y—Si—Al—O—N glass has a higher ballistic resistance than the standard float glass.

Surprisingly the D-value for the mixed glasses is of the same magnitude as Y—Si—Al—O—N glasses (typical values 2.0-2.4), while the density is considerably lower (typical values Y—Si—Al—O—N glasses 3.6-4.1 gm/cm³). From this it is concluded that the Mg—Y—Si—Al—O—N glass of the invention offers an improved ballistic resistance at the same weight or a similar or better ballistic resistance as the Y—Si—Al—O—N glasses at a reduced weight.

1. An armour material, comprising an oxynitride glass wherein the glass comprises glass network modifying cations of magnesium and glass network modifying cations of yttrium.

2. The material of claim 1, wherein the atom to atom ratio of yttrium to magnesium is in the range of 1:99 to 99:1.

3. The material of claim 1 wherein the total content of yttrium plus magnesium is 10 to 20 atom %, based on the total number of atoms in the material.

4. The material of claim 1 wherein the nitrogen content is in the range of 6 to 10 atom %, based on the total number of atoms in the material.

5. The material of claim 1 wherein the glass comprises 3.5 to 15 atom % aluminium, based on the total number of atoms in the material.

6. The material of claim 1 wherein the glass comprises 10 to 20 atom % silicon, based on the total number of atoms in the material.

7. The material of claim 1 wherein the oxynitride glass is transparent.

8. The material of claim 1 wherein the oxynitride glass comprises aluminium and silicon.

9. The material of claim 1 wherein the oxynitride glass comprises at least one additional network modifying cation selected from the group consisting of cations of calcium, terbium, gadolinium and scandium.

10. Oxynitride glass comprising 3.5 to 15 atom % aluminium, 6 to 10 atom % nitrogen, 10 to 20 atom % silicon, and further yttrium and magnesium, wherein the total content of yttrium and magnesium taken together is 10 to 20 atom %

11. The oxynitride glass of claim 10, comprising 6 to 10 atom % aluminium, 7 to 9 atom % nitrogen, 13 to 18 atom % silicon and wherein the total content of yttrium and magnesium taken together is 13 to 17 atom %.

12. The oxynitride glass of claim 10 wherein the atom to atom ratio of yttrium to magnesium is in the range of 1:99 to 99:1.

13. The oxynitride glass of claim 10 having a glass transition temperature, as determined by ISO 7884-8:1987, in the range of about 800 to about 1000° C.

14. A glass article comprising oxynitride glass of claim 10.

15. The glass article of claim 14 which has at least one curved surface.

16. The glass article of claim 14 which is monolithic.

17. The glass article of claim 14 selected from the group consisting of windows, screens, canopies and domes.

18. The glass article of claim 14 wherein a layer of said oxynitride glass is present as a composite with at least one polymer layer.

19. A transport or counter comprising the article of claim 14.
